(19) United States
(12) Patent Application Publication
(10) Pub. No.: US 2008/0098478 A1
(43) Pub. Date: Apr. 24, 2008

(54) System, Method and Computer Program Product for Administering Trust Dependent Functional Control over a Portable Endpoint Security Device

(75) Inventors: Vimal Vaidya, Fremont, CA (US); Sylvia Siu, Palo Alto, CA (US)

Correspondence Address: LAW OFFICE OF PHILIP A STEINER, 1212 MARSH STREET, SUITE 3, SAN LUIS OBISPO, CA, 93401, US

(73) Assignee: Redcannon, Inc., Fremont, CA (US)

(21) Appl. No.: 11/551,451

(22) Filed: Oct. 20, 2006

(51) Int. Cl. G06F 12/14; H04L 9/00; G06F 11/00; G06F 12/16; G06F 15/18; G08B 23/00

(52) U.S. Cl. 726/24; 713/176; 713/173

(57) ABSTRACT

A system, method and computer program product for administering trust dependent functional control over a portable endpoint security device (PEPS). A reconnoitering application in conjunction with a trust enforcement policy determines a relative trusted state of the host processing unit and administers trust dependent functional control over the PEPS in dependence on one or more trust dependent characteristics reconnoitered from the host processing unit. The trust dependent characteristics reconnoitered from the host processing unit may be location dependent, context dependent, hardware configuration dependent and logical state dependent.

### CROSS-REFERENCE TO RELATED APPLICATIONS

This application is a related application to co-pending U.S. patent application Ser. Nos. 10/739,552 filed on Dec. 17, 2003; Ser. No. 10/796,324 filed on Mar. 8, 2004; and Ser. No. 11/383,154 filed on May 12, 2006 to a common inventor and assignee; the aforementioned patent applications are hereby incorporated by reference in their entirety as if fully set forth herein.

### FIELD OF INVENTION

The present invention relates generally to a data processing system, method and computer program product and more specifically to functionality control in dependence on a relative trusted state of a host processing unit in which a portable endpoint security device is coupled thereto.

### BACKGROUND

The corporate workforce is becoming increasingly mobile and dependent on accessing electronic information such as emails, documents, financial information, and maintaining contact with business associates while traveling or otherwise being displaced from a central work location. Frequently, workers carry laptops, cell phones, PDA's, Blackberries™ and integrated versions of the latter and former to stay in touch with their home offices. However, in the majority of situations, a worker will have access to a remote computer system owned and/or managed by a third party but is hesitant to use these available resources due to concerns of malware being installed on the remote computer systems; and, the possibility of another recovering sensitive, proprietary and/or personal information left behind in cookies, temporary files, browsing histories and the like.

For example, Internet Cafes are becoming ubiquitous in most major cities around the world, as well as in most major hotel chains and larger airports; all of which have computing resources available that would allow a worker to check for important emails, send and receive documents and allow other forms of common electronic commerce if sufficient safeguards were available. Preferably, these safeguards would be disposed in a highly portable device which readily interfaces with these resources, prevents malware from compromising security or data integrity, provides trusted remote access to the worker's private network and further avoids leaving sensitive information behind.

In many instances, the available computing resources incorporate sufficient safeguards which are redundant to those contained in the highly portable device, thus negatively impacting a user's productivity, providing unnecessary transactions and adding to the processing burden of the available computing resource. Therefore, a highly portable device which determines the relative trusted state of the available computing resource would be highly advantageous.

### SUMMARY

This disclosure addresses the deficiencies of the relevant art and provides exemplary systematic, methodic and computer program product embodiments which incorporates in various embodiments, a portable endpoint security device operatively coupled to a host processing unit having an unknown but generally ascertainable trusted state. The various embodiments presented herein provide exemplary mechanisms for determining a relative trusted state of a host processing unit and where permitted by a trust enforcement policy, simplify the usage of the portable end-point security device (PEPS) and improve the overall system performance of the host processing unit while maintaining an adequate level of security.

In an exemplary systematic embodiment, a system for administering trust dependent functional control over a portable endpoint security device may be provided. This exemplary systematic embodiment comprises a trust enforcement policy accessible by the portable endpoint security device. The trust enforcement policy includes one or more predefined trust dependent characteristics for which the trust dependent functional control may be administered. A reconnoitering application may be further provided which includes instructions executable by a processor to reconnoiter one or more trust dependent characteristics associated with the host processing unit; determine a relative trusted state of the host processing unit in dependence on the trust enforcement policy and the one or more trust dependent characteristics reconnoitered from the host processing unit; and administer the trust dependent functional control over the portable endpoint security device in dependence on the determined relative trusted state of the host processing unit.

In a first related exemplary systematic embodiment, the administered trust dependent functional control over the portable endpoint security device may be one or more of; controlling access to a secure memory area internal to the portable endpoint security device and controlling the transfer of information between a networked resource and the portable endpoint security device.

In a second related exemplary systematic embodiment, the administered trust dependent functional control over the portable endpoint security device may be one or more of; limiting access to an internal anti-malware application, displaying graphical indicia of malware detected by the reconnoitering application on the host processing unit, removing the detected malware from the host processing unit and any combination thereof.

In a third related exemplary systematic embodiment, the administered trust dependent functional control over the portable endpoint security device may be one or more of; controlling offline usage of temporarily cached information and controlling audit functions internal to the portable endpoint security device.

In a fourth related exemplary systematic embodiment, the administered trust dependent functional control over the portable endpoint security device may be one or more of, controlling distribution of an internally maintained application, controlling usage of the internally maintained application, providing change management of the internally maintained application and any combination thereof.

In a fifth related exemplary systematic embodiment, the administered trust dependent functional control over the portable endpoint security device may be one or more of, controlling distribution of a document, controlling access to the document and providing change management of the document.

In a sixth related exemplary systematic embodiment, the administered trust dependent functional control over the portable endpoint security device may be one or more of; determining if an existing host application has an executable association with an internally maintained file, allowing the host application to access the internally maintained file, executing an internally maintained application, downloading an internally maintained application, executing a remote client application and any combination thereof.

In a seventh related exemplary systematic embodiment, at least one of the one or more trust dependent characteristics reconnoitered from the host processing unit may be location dependent, context dependent and any combination thereof.

In an eighth related exemplary systematic embodiment, the location dependence may be inferred from one or more of, an IP address, an IP address range, a MAC address, a domain name, a set of GPS coordinates and any combination thereof.

In a ninth related exemplary systematic embodiment, the context dependence may be inferred from one or more of, a memory execution stack, a registry entry, a Windows COM object, a Windows DCOM object, a DSOM object, a service, a process and any combination thereof.

In a tenth related exemplary systematic embodiment, the context dependence may be inferred from one or more of, a footprint of an operating system, a hardware configuration, an object, a binary file, a security policy, a verification indicia and any combination thereof.

In an eleventh related exemplary systematic embodiment, the verification indicia may be one or more of; a cryptogram, a digital credential, a digital signature, a checksum value, a cyclic redundancy check value, a hash value and any combination thereof.

In a twelfth related exemplary systematic embodiment, the determined relative trusted state of the host processing unit may be determinative of a level of access a user may be afforded to information contained in or available using the portable endpoint security device.

In a thirteenth related exemplary systematic embodiment, the determined relative trusted state may be determinative of a level of required user interaction with the portable endpoint security device.

In a fourteenth related exemplary systematic embodiment, the administered trust dependent functional control over the portable endpoint security device may be established for one or more of, internal data manipulation, an application manipulation, an application execution and any combination thereof.

In a fifteenth related exemplary systematic embodiment, the application execution includes execution of internal maintained applications when the relative trusted state of the host processing unit may be low and execution of external applications when the relative trusted state of the host processing unit may be high.

In a sixteenth related exemplary systematic embodiment, the administered level of functional control over the portable endpoint security device may be scalable in at least partial dependence on the determined relative trusted state of the host processing unit.

In an exemplary methodic embodiment, a method for administering trust dependent functional control over a portable endpoint security device comprising a trust enforcement policy including one or more predefined trust dependent characteristics for which the trust dependent functional control may be to be administered coupled to a reconnoitering application may be provided. The exemplary methodic embodiment comprises instructions executable by a processor for;

reconnoitering one or more trust dependent characteristics associated with a host processing unit;

determining a relative trusted state of the host processing unit in dependence on the trust enforcement policy and the trust dependent characteristics reconnoitered from the host processing unit; and,

administering the trust dependent functional control over the portable endpoint security device in dependence on the determined relative trusted state of the host processing unit.

In a first related exemplary methodic embodiment, further instructions executable by the processor are provided for performing one or more of, controlling access to a secure memory area internal to the portable endpoint security device and controlling the transfer of information between a networked resource and the portable endpoint security device.

In a second related exemplary methodic embodiment, further instructions executable by the processor are provided for performing one or more of, limiting access to an internal anti-malware application, displaying graphical indicia of malware detected by the reconnoitering application on the host processing unit, removing the detected malware from the host processing unit and any combination thereof.

In a third related exemplary methodic embodiment, further instructions executable by the processor are provided for performing one or more of, controlling offline usage of temporarily cached information and controlling audit functions internal to the portable endpoint security device.

In a fourth related exemplary methodic embodiment, further instructions executable by the processor are provided for performing one or more of, controlling distribution of an internally maintained application, controlling usage of the internally maintained application, providing change management of the internally maintained application and any combination thereof.

In a fifth related exemplary methodic embodiment, further instructions executable by the processor are provided for performing one or more of, controlling distribution of a document, controlling access to the document and providing change management of the document.

In a sixth related exemplary methodic embodiment, further instructions executable by the processor are provided for performing one or more of, determining if an existing host application has an executable association with an internally maintained file, allowing the host application to access the internally maintained file, executing an internally maintained application, downloading an internally maintained application, executing a remote client application and any combination thereof.

In a seventh related exemplary methodic embodiment, at least one of the one or more trust dependent characteristics reconnoitered from the host processing unit may be location dependent, context dependent and any combination thereof.

In an eighth related exemplary methodic embodiment, the location dependence may be inferred from one or more of, an IP address, an IP address range, a MAC address, a domain name, a set of GPS coordinates and any combination thereof.

In a ninth related exemplary methodic embodiment, the context dependence may be inferred from one or more of, a memory execution stack, a registry entry, a Windows COM object, a Windows DCOM object, a DSOM object, a service, a process and any combination thereof.

In a tenth related exemplary methodic embodiment, the context dependence may be inferred from one or more of, a footprint of an operating system, a hardware configuration, an object, a binary file, a security policy, verification indicia and any combination thereof.

In an eleventh related exemplary methodic embodiment, the verification indicia may be one or more of, a cryptogram, a digital credential, a digital signature, a checksum value, a cyclic redundancy check value, a hash value and any combination thereof.

In a twelfth related exemplary methodic embodiment, the determined relative trusted state of the host processing unit may be determinative of a level of access a user may be afforded to information contained in or available using the portable endpoint security device.

In a thirteenth related exemplary methodic embodiment, the determined relative trusted state may be determinative of a level of required user interaction with the portable endpoint security device.

In a fourteenth related exemplary methodic embodiment, the administered trust dependent functional control over the portable endpoint security device may be established for one or more of, internal data manipulation, application execution and any combination thereof.

In a fifteenth related exemplary methodic embodiment, the internal data manipulation may be one or more of, data, object and application manipulation.

In a sixteenth related exemplary methodic embodiment, the application execution includes execution of internal maintained applications when the relative trusted state of the host processing unit may be low and execution of external applications when the relative trusted state of the host processing unit may be high.

In a seventeenth related exemplary methodic embodiment, the administered level of functional control over the portable endpoint security device may be scalable in at least partial dependence on the determined relative trusted state of the host processing unit.

In an exemplary computer program product (CPP) embodiment, a program for administering trust dependent functional control over a portable endpoint security device may be provided. The program may be embodied in a tangible form comprising instructions executable by a processor for; reconnoitering one or more context dependent characteristics associated with a host processing unit; determining a relative trusted state of the host processing unit in dependence on a trust enforcement policy and the one or more context dependent characteristics reconnoitered from the host processing unit and administering the trust dependent functional control over the portable endpoint security device in dependence on the determined relative trusted state of the host processing unit.

In a first related exemplary CPP embodiment, further instructions executable by the processor are provided for performing one or more of; controlling access to a secure memory area internal to the portable endpoint security device and controlling the transfer of information between a networked resource and the portable endpoint security device.

In a second related exemplary CPP embodiment, further instructions executable by the processor are provided for performing one or more of, limiting access to an internal anti-malware application, displaying graphical indicia of malware detected by the reconnoitering application on the host processing unit, removing the detected malware from the host processing unit and any combination thereof.

In a third related exemplary CPP embodiment, further instructions executable by the processor are provided for performing one or more of; controlling offline usage of temporarily cached information and controlling audit functions internal to the portable endpoint security device.

In a fourth related exemplary CPP embodiment, further instructions executable by the processor are provided for performing one or more of; controlling distribution of an internally maintained application, controlling usage of the internally maintained application, providing change management of the internally maintained application and any combination thereof.

In a fifth related exemplary CPP embodiment, further instructions executable by the processor are provided for performing one or more of; controlling distribution of a document, controlling access to the document and providing change management of the document.

In a sixth related exemplary CPP embodiment, further instructions executable by the processor are provided for performing one or more of; determining if an existing host application has an executable association with an internally maintained file, allowing the host application to access the internally maintained file, executing an internally maintained application, downloading an internally maintained application, executing a remote client application and any combination thereof.

In a seventh related exemplary CPP embodiment, at least one of the one or more trust dependent characteristics reconnoitered from the host processing unit may be location dependent, context dependent and any combination thereof.

In an eighth related exemplary CPP embodiment, the location dependence may be inferred from one or more of; an IP address, an IP address range, a MAC address, a domain name, a set of GPS coordinates and any combination thereof.

In a ninth related exemplary CPP embodiment, the context dependence may be inferred from one or more of, a memory execution stack, a registry entry, a Windows COM object, a Windows DCOM object, a DSOM object, a service, a process and any combination thereof.

In a tenth related exemplary CPP embodiment, the context dependence may be inferred from one or more of; a footprint of an operating system, a hardware configuration, an object, a binary file, a security policy, verification indicia and any combination thereof.

In an eleventh related exemplary CPP embodiment, the verification indicia may be one or more of; a cryptogram, a digital credential, a digital signature, a checksum value, a cyclic redundancy check value, a hash value and any combination thereof.

In a twelfth related exemplary CPP embodiment, the determined relative trusted state of the host processing unit may be determinative of a level of access a user may be afforded to information contained in or available using the portable endpoint security device.

In a thirteenth related exemplary CPP embodiment, the determined relative trusted state may be determinative of a level of required user interaction with the portable endpoint security device.

In a fourteenth related exemplary CPP embodiment, the administered trust dependent functional control over the portable endpoint security device may be established for one or more of; internal data manipulation, application manipulation, application execution and any combination thereof.

The various exemplary systematic, methodic and computer program product embodiments described above are provided in related numeric embodiments for convenience only. No limitation to the various exemplary embodiments is intended by the use of the numeric designations.

### BRIEF DESCRIPTION OF THE DRAWINGS

The features and advantages will become apparent from the following detailed description when considered in conjunction with the accompanying drawings. Where possible, the same reference numerals and characters are used to denote like features, elements, components or portions. Optional components or features may be shown in dashed or dotted lines. When applicable, optional components or features are described as such in the detailed description provided below. It is intended that changes and modifications can be made to the described embodiments without departing from the true scope and spirit of the various inventive embodiments.

FIG. 1—depicts a generalized and exemplary block diagram of a host processing unit as described in the various embodiments.

FIG. 1A—depicts a generalized and exemplary block diagram of a portable endpoint security device.

FIG. 2—depicts an exemplary detailed block diagram of various exemplary characteristics used to determine a relative trusted state of the host processing unit as described in the various embodiments.

FIG. 3—depicts an exemplary detailed block diagram of the various modules of the portable end-point security device (PEPS) which may be functionally controlled in dependence on a determined relative trusted state of the host processing unit as described in the various embodiments.

FIG. 4—depicts an exemplary flow chart of a process for determining the relative trusted state of the host processing unit and the relationship of the various characteristics for administering functional control over various functionalities incorporated the portable end-point security device (PEPS) as described in the various embodiments.

FIG. 5—depict an exemplary flow chart of a process for determining whether to utilize applications which may be present on the host processing unit in dependence on the determined relative trusted state of the host processing unit.

### DETAILED DESCRIPTION

In various embodiments, the ability to provide functional control over one or more integrated features of a portable endpoint security device (PEPS) is provided. Control over the various integrated features is dependent on the determined relative trusted state of a host computer system in which the PEPS is operatively coupled. In general, the greater the determined relative level of trust of the computer system to which the PEPS is operatively coupled, the less reliance is placed on the PEPS, thus simplifying user interactions with the PEPS and improving overall performance by permitting certain of the integrated features to be performed on the host computer system rather than within the secure domain of the PEPS. Since the PEPS may be configured to work with non-traditional computer systems, for example, portable data assistants (PDA), smart phones and other intelligent devices, the term “host processing unit” is used to refer to the broader category of intelligent devices capable of being operatively coupled to a PEPS. For certain installations, the PEPS may be configured as a software token which resides in a protected area of memory of the host processing unit.

Where necessary, computer programs, algorithms and routines are envisioned to be programmed in a high level, preferably an object oriented language, for example Java™, C, C++, C#, CORBA or Visual Basic™.

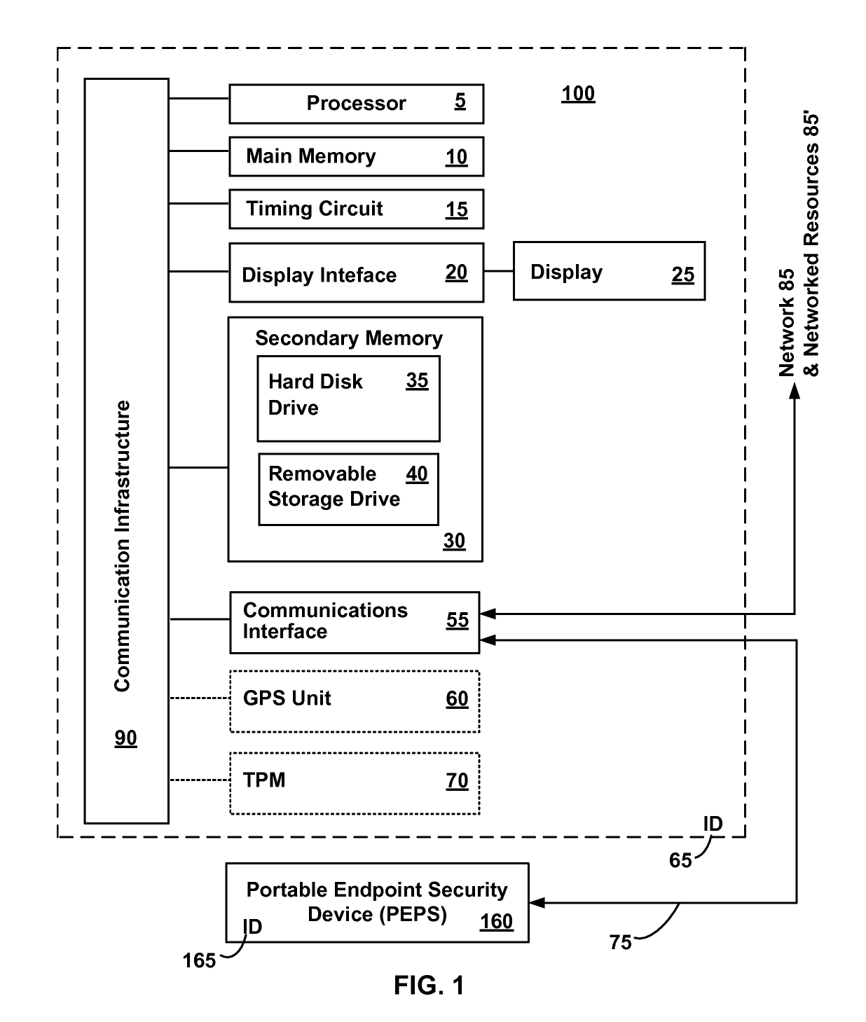

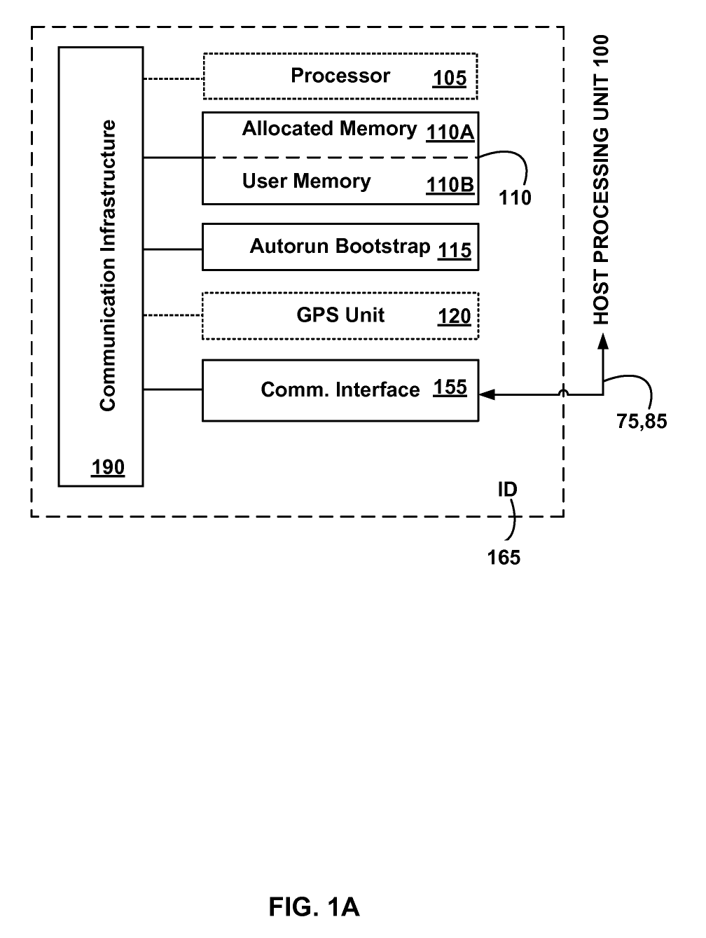

Referring to FIG. 1, an exemplary block diagram of a host processing unit 100 is depicted. The host processing unit 100 may be configured as a general purpose computer system, laptop, smart phone, PDA or another intelligent device having compatible communications and data formats. The host processing unit 100 includes a communications infrastructure 90 used to transfer data, memory addresses where data files are to be found and control signals among the various components and subsystems associated with the host processing unit 100.

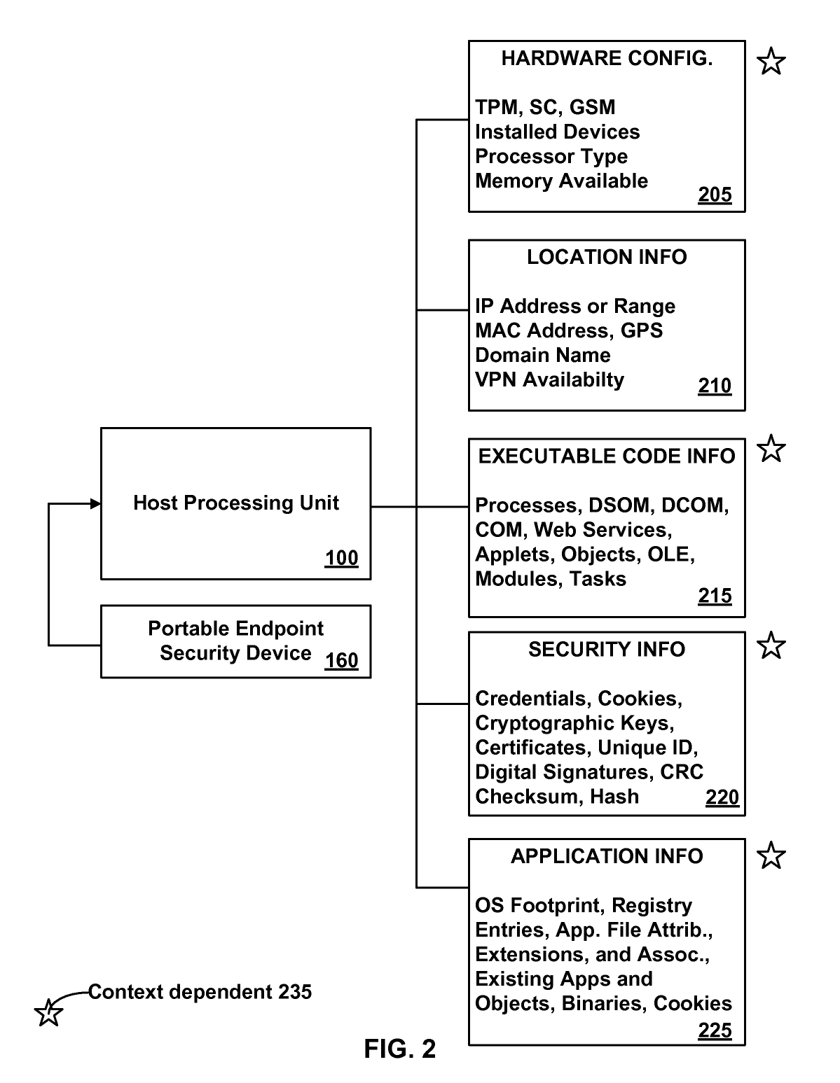

A processor 5 is provided to interpret and execute logical instructions stored in the main memory 10. The main memory 10 is the primary general purpose storage area for instructions and data to be processed by the processor 5. A timing circuit 15 is provided to coordinate programmatic activities within the host processing unit 100 and the PEPS 160 as shown in FIG. 2. The timing circuit 15 may be used as a watchdog timer, clock or as a counter arrangement and may be programmable.

The processor 5, main memory 10 and timing circuit 15 are directly coupled to the communications infrastructure 90. A display interface 20 is provided to drive a display 25 associated with the host processing unit 100. The display interface 20 is electrically coupled to the communications infrastructure 90 and provides signals to the display 25 for visually outputting both graphical displays and alphanumeric characters. The display interface 20 may include a dedicated graphics processor and memory (not shown) to support the displaying of graphics intensive media. The display 25 may be of any type (e.g., cathode ray tube, gas plasma, LCD.)

A secondary memory subsystem 30 is provided which houses retrievable storage units such as a hard disk drive 35, a removable storage drive 40, and an optional logical media storage drive 45. The removable storage drive 40 may be a replaceable hard drive, optical media storage drive or a solid state flash RAM device. The logical media storage drive 45 may include a flash RAM device, an EEPROM encoded with one or programs used in the various embodiments described herein, or optical storage media (CD, DVD.)

A generalized communications interface 55 is provided which allows the host processing unit 100 to communicate over one or more networks 85. The network 85 may be of a wired, optical, or radio frequency type normally associated with computer networks for example, wireless computer networks based on various IEEE standards 802.11x, where x denotes the various present and evolving wireless computing standards, for example WiMax 802.16 and WRANG 802.22.

Alternately, digital cellular communications formats compatible with for example GSM, 3G, CDMA, TDMA and evolving cellular communications standards. In a third alternative embodiment, the network 85 may include hybrids of computer communications standards, cellular standards, cable networks and/or satellite communications standards.

The host processing unit 100 includes an operating system for example, Microsoft™ Windows 2000, XP and later versions thereof; or, if arranged as dedicated network appliance, an embedded operating environment for example, Microsoft Windows CE. The host processing unit 100 further includes the necessary hardware and software drivers necessary to fully utilize the devices coupled to the communications infrastructure 90 and one or more programs which enable the host processing unit 100 to communicate with other intelligent devices and networked resources 85′ over the network 85.

The host processing unit 100 may include standard user software applications common in office suite type arrangements such as a word processor, spreadsheet, database, presentation, Internet browser and email software. Additional software applications may include remote communications clients for example, Citrix™, virtual private networking (VPN) software, malware protection applications and two or more factor authentication packages. The term “malware,” is used generically to refer to malevolent computer viruses, worms and spyware.

In an embodiment, an accessible unique identifier ID 65 is provided which may be useful for determining whether the host processing unit 100 in which the PEPS 160 is operatively coupled is considered “trusted.” The term “trusted” means that the host processing unit 100 and the applications executed thereby can be trusted to follow their intended programming with a lower possibility of inappropriate activities such as surreptitiously recording passwords, monitoring secure transactions, and/or altering data.

In an optional embodiment, the host processing unit 100 may include a GPS unit 60 which provides geographical coordinates useful for determining a trusted location. GPS units 60 are now commonly integrated into a wide range of intelligent devices, (e.g., cellular telephones,) in which the PEPS 160 may be operatively coupled to or directly integrated within as well.

In an optional embodiment, a trusted platform module (TPM) 70 or equivalent hardware based security device may be coupled to the communications infrastructure 90. The TPM 70 is compatible with the applicable trusted computing group industry standard specifications downloadable from www.trustedcomputinggroup.org.

In an embodiment, the PEPS 160 may be operatively coupled 75 to the communications interface 55 by a universal serial bus (USB) connection. However, other arrangements known in the relevant art such as PCMCIA, BlueTooth™, wireless network 85, serial RS-232 or infrared optical connections to the communications interface 55 may be used in combination or as a replacement for the USB connection. In an alternate embodiment, the PEPS 160 may be configured as a software based token which is maintained in a secure area of the main memory 10.

Referring to FIG. 1A, an exemplary block diagram of PEPS 160 is provided. In various embodiments, the PEPS 160 is disposed in a highly portable form factor similar to common “pen” or “flash” memory drives. In other embodiments, the PEPS 160 may be incorporated into common flash memory card form factors, for example, CF, SD and XD form factors and maintained as a software token.

An optional microprocessor 105 may be provided to perform cryptographic operations and other functions internally rather than utilizing the processor 5 associated with the host processing unit 100. For example, an ARM7 32-bit processor manufactured by ARM Holdings plc., provides a suitable family of low-power 32-bit RISC microprocessor cores optimized for cost and power-sensitive consumer applications. If present, the processor 105 is operatively coupled to a communications infrastructure 190.

A memory subsystem 110 is operatively coupled to the communications infrastructure 190. In various embodiments, the memory subsystem 110 is partitioned into two or more portions 110A, 110B. One portion of the partitioned memory 110 contains the applications and data used in performing the various PEPS functions including but not limited to secure storage, stealth browser and email applications, auditing applications, secure document distribution, license management, application update management, authentication, cryptography, temporarily cached applications and malware protection. A second portion of the memory 110B is provided for direct user storage of data. The actual number of partitions provided in the memory subsystem 110 may be varied to suit various functional requirements.

In an embodiment, the PEPS 160 is configured as a USB peripheral device which utilizes portions of the operating system (e.g., WINSOCK, MSGINA, LOGON, RUNDLL32 in Microsoft Windows™) and the processor 5 associated with the remote host processing unit 100 to operate and communicate over the USB connection 75 and/or network 85.

An Autorun bootstrap module 115 is provided which causes the host processing unit 100 to detect and access the PEPS 160 to operatively load the necessary executable code into the main memory 10 of the remote host processing unit 100. In an embodiment, the detection of the coupled PEPS 160 is accomplished using “Plug N Play” technology known in the relevant art. The executable code is loaded into the main memory 10 of the remote host processing unit 100 by Autorun bootstrap module 115 and provides the necessary extensions, files, hooks and/or libraries in order to utilize the remaining functions associated with the PEPS 160.

In an embodiment, the majority of the processing is performed by the processor 5 associated with remote host processing unit 100A. Additional processing may be performed by the internal processor 105 for certain cryptographic and other functions. In an optional embodiment, the PEPS 160 may include a GPS unit 120 which provides geographical coordinates useful for determining a trusted location and/or host processing unit 100.

A communications interface 155 is operatively coupled to the communications infrastructure 190 to allow the various modules and subsystems associated with the PEPS 160 to communicate with the host processing unit 100.

In an embodiment, the PEPS 160 is intended to be compliant with the U3 platform specifications for a smart device. Information regarding the hardware and software specifications may be downloaded from www.u3.com. The U3 platform provides a uniform programmatic architecture for smart drive computing. The U3 platform enables hardware manufacturers and software developers to create U3 smart products which are compatible with all U3 applications. Software which is compliant with the U3 platform specification allows for the mobile applications and personal workspace portability as described in the various embodiments herein. The U3 platform specification is herein incorporated by reference. One skilled in the art will appreciate that other arrangements may be used in conjunction with or in lieu of the U3 platform.

In an embodiment, either the processor 5 associated with the host processing unit 100 and/or the processor 105 associated with the PEPS 160 may execute the necessary applications as described herein.

Lastly, each PEPS 160 is encoded with a unique identification code ID 165 which in an embodiment may be burned into an internal EEPROM associated with the PEPS 160 during manufacturing. In an alternate embodiment, the unique identification code ID 165 may be installed as a permanent file. The unique identifier 165 which is used to associate a particular PEPS 160 with an assigned user and/or an authorized entity.

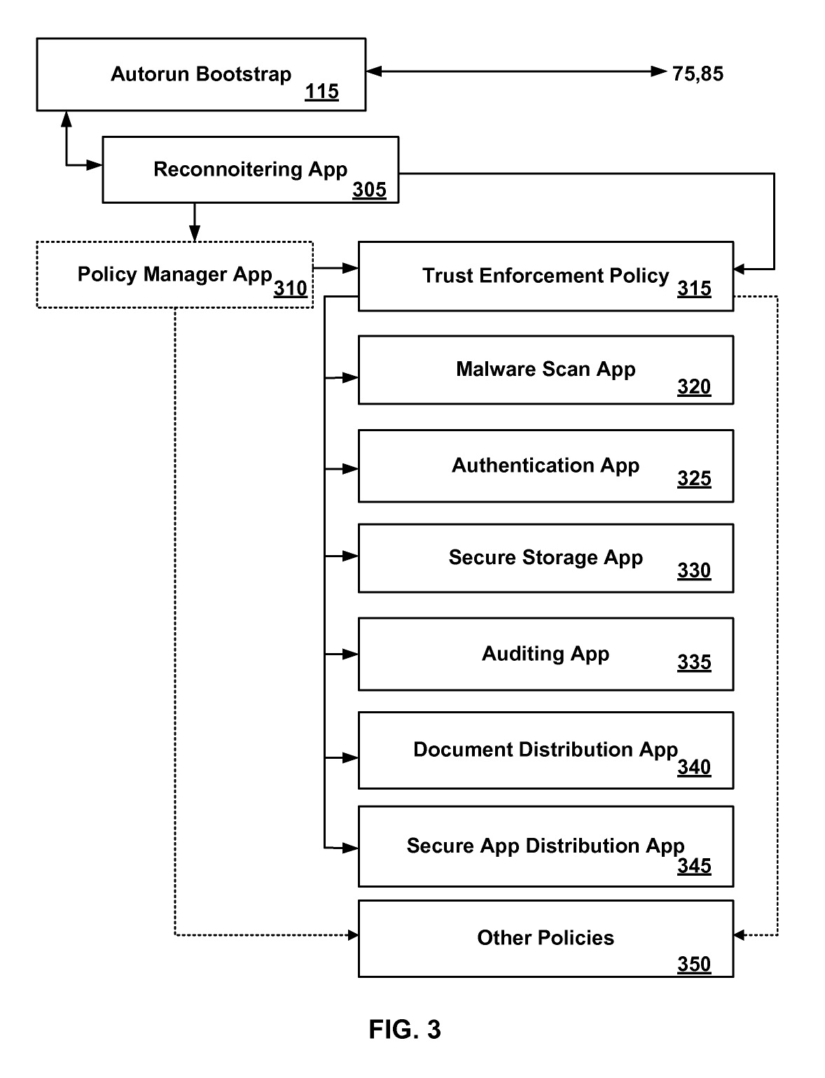

FIG. 2 depicts an exemplary detailed block diagram of various exemplary characteristics used to determine a relative trusted state of the host processing unit 100. When the portable endpoint security device 160 is operationally coupled to the host processing unit 100, the Autorun bootstrap module 115 causes the host processing unit 100 to detect and access the PEPS 160 to operatively load the necessary executable code, into the main memory 10 of the remote host processing unit 100. The operatively loaded executable code is hereinafter referred to as a reconnoitering application 305 (FIG. 3.) In a Windows embodiment, loading of the various applications may be performed using an .MSI file, simulated CD ROM bootstrap or third party installation application.

The reconnoitering application 305 is programmed to determine the relative trusted state of the host processing unit based on reconnoitered information related to the five broad categories of hardware configuration 205, location information 210, executable code information 215, security information 220 and application information 225. The hardware configuration information 205 includes a TPM 70 or (equivalent smartcard or GSM chip, the hardware devices coupled to the communications infrastructure 90, expected processor 5 information (type, speed, manufacturer,) available main memory 10, hard drive 35 information (type, speed, capacity, manufacturer) and related components and expected device peripherals which may be used to determine the relative level of trust of the host processing unit 100 based on preestablished policy information. Much of the reconnoitered information may be obtained by receiving information from tools and related applications included with the operating system.

For example, in Microsoft Windows XP™ there are a variety of tools available for example; taskmanager.exe; msconfig.exe; msinfo32.exe; which when queried, will provide some or all of the information necessary to determine the relative trusted state of the host processing unit 100. Additional information concerning these and other system tools is available at www.microsoft.com (e.g., Windows XP Resource Kit.)

The location information 210 includes IP address range, media access control (MAC) address, domain name, established virtual private network (VPN.) The executable code information 215 includes executing processes, web services, remote procedure calls including Windows COM and DCOM objects, CORBA DSOM objects, Java applets (remote method invocations) and executing programs. The security information 220 includes user and system credentials, browser cookies, cryptographic keys, digital certificates, checksum values, cyclic redundancy check values, digital signatures, hashes and one or more unique identifiers associated with the host processing unit 100, user or entity or enterprise.

The application information 225 includes a footprint such as a checksum, hash or digital signature, size, and/or version of the operating system, installed programs, file attributes, file extensions, program associations, and objects. Alternately, or in conjunction with the footprint information, an inventory of the installed programs may be used as well. Entries in the operating system's registry may be used to determine which programs, processes, services, applications and/or objects are functionally installed on the host processing unit 100. The hardware configuration 205, executable code information 215, security information 220 and application information 225 are considered context dependent 230. For purposes of this specification, the term “context dependent,” is defined as; of, or pertaining to one or more characteristics of a process, object, function, application or data set whose meaning is dependent on the surrounding environment.

FIG. 3 depicts an exemplary detailed block diagram of the various program modules of the PEPS 160 which may be functionally controlled by the information reconnoitered from the host processing unit 100 by the reconnoitering application 305. As previously discussed, the Autorun bootstrap 115 loads the reconnoitering application 305 into the memory 10 of the host processing unit 100. In an embodiment, the reconnoitering application 305 determines which of the trusted state criteria to use (i.e., location information 205, executing code information 210, security information 215, and/or application information 220) to determine the relative trusted state of the host processing unit 100 based on information prescribed in the trust enforcement policy 315.

One skilled in the art will appreciate that references to the reconnoitering application 305 may be made in both singular and plural form. No limitation is intended by such grammatical usage as one skilled in the art will appreciate that multiple programs, objects, subprograms, routines, algorithms, applets, processes, services, etc. may be implemented programmatically to implement the various embodiments described herein.

In an embodiment, one or more trust enforcement policies 315 may be used to prescribe functional control over how the PEPS 160 interacts with the host processing unit 100 under a wide variety of operating conditions. For example, a highly trusted host processing unit 100 may perform almost all the functions of the PEPS 160 while a host processing unit 100 having limited or indeterminable trust levels may be limited by the trust enforcement policy 315 to many functions being performed within the PEPS 160, if at all. The trust enforcement policy 315 may also provide a mechanism in which secure document and/or application distribution may be accomplished in dependence on the level of trust reconnoitered by the reconnoitering application 305.

In another example, the trust enforcement policy 315 may prescribe that certain of the more common user applications, such as a word processing application, may be suspect based on variations in the word processing applications' predefined file size and the actual file size reconnoitered from the host processing unit 100. The policy may provide for the downloading of a limited version of the word processing program over the network 85 from a network resource 85′ which is then used as an alternative to the suspect local version existing on the host processing unit 100. If an external browser is likewise suspect, the trust enforcement 315 policy may limit the user to performing offline transactions with a cached website which is then resynchronized with the actual website when a location having a higher trust is established with the PEPS 160.

In an embodiment, the trust enforcement policy 315 contains pre-determined trust criteria, as examples, trusted domain names, IP address and IP address ranges and/or unique identifiers which are identified by the reconnoitering application 305 and used to determine the relative trusted state of the host processing unit 100. The domain name is intended to include Internet and non-Internet domain names.

In another embodiment, the trust enforcement policy 315 contains host processing unit configuration information which requires a more intensive and dynamic examination to determine the relative trusted state of the host processing unit 100. For example, the trust enforcement policy 315 may require the reconnoitering application 305 to determine if the host processing unit 100 has active malware protection, whether the malware protection is up to date and/or whether a firewall is present. The trust enforcement policy 315 may also include Boolean logical operators to combine the various dynamic trust state criteria. One skilled in the art will appreciate that both the predefined and dynamic characteristics associated with the host processing unit 100 may be used to determine the relative trusted state of the host processing unit 100.

In an embodiment, once the reconnoitering application 305 has determined a relative trusted state of the host processing unit 100, the trust enforcement policy 315 may dispense with certain generally required user and/or PEPS 160 transactions for ease of use, improved system performance without degrading a required level of security. The changes to the generally required user and/or PEPS 160 transactions may have a tiered structure which requires certain transactions while dispensing with other transactions having minimal or no beneficial effect.

The exerted functional control enforced by the trust enforcement policy 315 includes a malware scan 320, which is generally required for all transactions involving the PEPS 160; user authentication 325, likewise generally required for all transactions involving the PEPS 160; secure storage 330, access to secure storage is dependent on user authentication and may be further dependent on other policies 350; auditing and tracking 335, is generally required for all transactions involving the PEPS 160; document distribution 340, access to document distribution resources is dependent on user authentication and may further be dependent on other policies 350; secure application distribution 345, likewise, secure application distribution resources is dependent on user authentication and may further be dependent on other policies 350 contained within the PEPS 160.

In an embodiment, the PEPS 160 may be provided with multiple sets of trust enforcement policies; where each trust enforcement policy is associated with a location and/or context dependent characteristic which is reconnoitered from the host processing unit 100. For example, the reconnoitering application 305 may determine that a particular trusted application is present on the host processing unit 100 by the presence of a particular registry key entry. Alternately, or in conjunction therewith, the reconnoitering application 305 may determine that a malware process is executing which requires that the malware be removed or quarantined before allowing further transactions with the PEPS 160. In a related embodiment, the user may be alerted to the presence of the malware, for example, by a color coded graphic (e.g., green—no malware detected, yellow—malware detected but not a critical threat or red—critical threat malware detected.) Some examples of a trust dependent functional control arrangement are provided in Table 1 below.

TABLE 1
EXEMPLARY TRUST DEPENDENT FUNCTIONAL CONTROL

| POLICY CRITERIA | FUNCTIONAL CONTROL |
|---|---|
| Active Anti-Malware app. Detected | Bypass malware scan |
| Recent malware scan verified | Bypass malware scan |
| Trusted domain name detected | Bypass user authentication |
| Trusted IP range detected | Bypass user authentication |
| Trusted unique ID | Bypass all internal functions unless required by policy(ies) |
| GPS coordinates verified | Bypass user authentication |
| Digital certificate verified | Bypass user authentication |
| Verified cryptographic key | Bypass user authentication |
| OS Footprint verified | Use host applications; download application |
| | associated with file extension if necessary |
| Trusted apps verified | Use host applications; allow secure |
| | application distribution. |
| Trusted Platform Module detected | Bypass all internal functions unless required by policy(ies) |
| Trusted VPN detected | Use detected VPN |
| Trusted executing processes | Allow secure apps/document distribution |
| Limited or no Trust | Disallow viewing of information in the |
| | PEPS vault or secure memory. |
| Limited or no Trust | Disallow addition of information to the |
| | PEPS vault or secure memory. |
| Limited or no Trust | Disallow file exchanges with a central |
| | management server. |
| Limited or no Trust | Use internal cache of |
| | authentication passwords. |
| Limited or no Trust | Use internal PEPS applications or remote client only. |

In an exemplary implementation, the generally required malware scan 320 may be bypassed if the reconnoitering application 305 detects the presence of an anti-malware application installed on the host processing unit 100. The detection process may be based on a pre-determined or known anti-malware application (e.g., Norton Anti-Virus™), a detected executing anti-malware process, or the presence of a recent malware scan log. The executing process may be determined, for example, in a Microsoft Windows XP environment using the taskmanager.exe or msinfo32.exe applications. Similar information is available from resources provided in Linux™, Unix™ and Apple™ operating systems.

In another exemplary implementation, user authentication 325 may be bypassed if an automatically verified digital certificate is located on the host processing unit 100 and PEPS 160. In this implementation, the presence of a digital certificate provides sufficient information to assume the user associated with the PEPS 160 is the same user identified by the digital certificate.

In an embodiment, either the processor 5 associated with the host processing unit 100 and/or the processor 105 associated with the PEPS 160 may execute the necessary applications as described herein.

In a final exemplary implementation, all internal functions of the PEPS 160 may be bypassed if a trusted and verified unique identifier has been located by the reconnoitering application 305. In this exemplary embodiment, the verified unique identifier provides sufficient indicia that the host processing unit 100 is a trusted platform (e.g., the users own workstation) which allows all functions normally performed by the PEPS 160 to be performed by the host processing unit 100.

In an embodiment, a policy manager application 310 provides the actual trust enforcement policy 315 within the PEPS 160 based on information reconnoitered by the reconnoiter application 305 executing on the host processing unit 100. The policy manager application 310 may be a separate application, method or object associated with the reconnoitering application 305. One skilled in the art will appreciate that one or more separate applications may be used to accomplish the trust policy enforcement as described herein. The policy manager 310 ensures that all transactions (both internal and external) are performed in accordance with the trust enforcement policy 315. For example installing a new internal application within the PEPS 160 may require that a proper digital signature accompany the new internal application prior to allowing its installation.

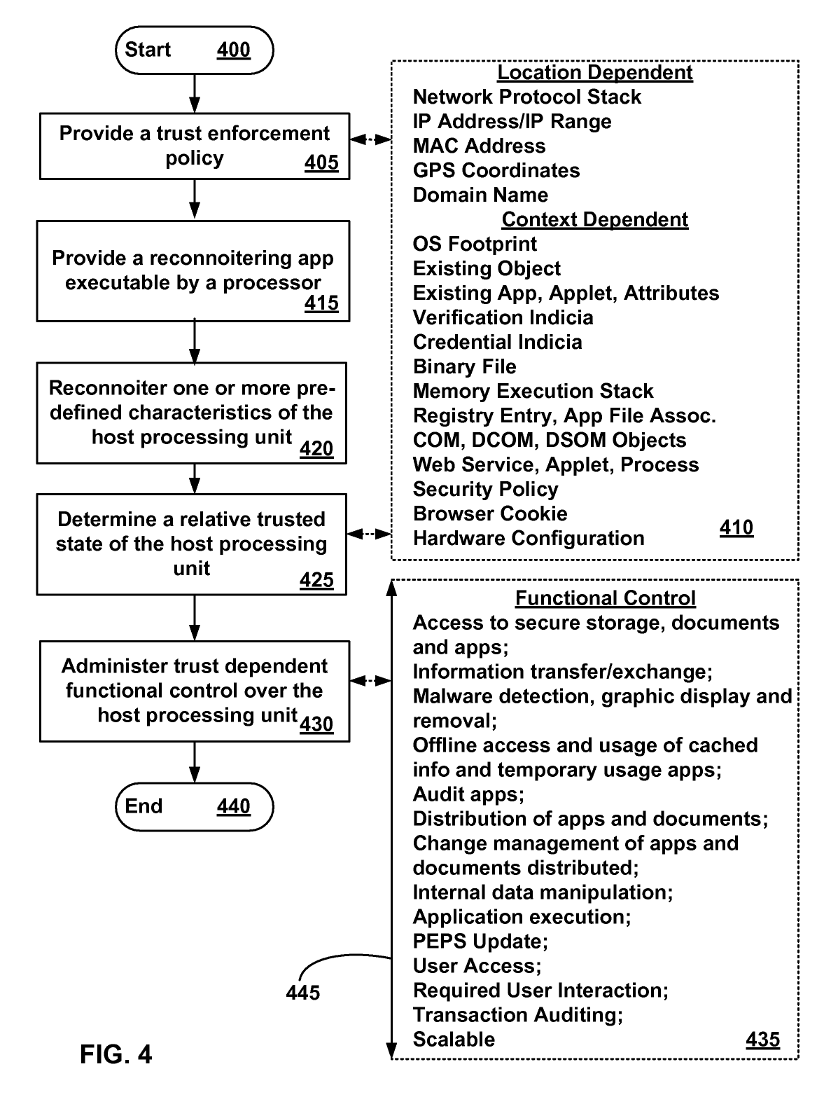

FIG. 4 depicts an exemplary flow chart of a process for determining the relative trusted state of the host processing unit and the relationship of the various context dependent characteristics for administering functional control over the PEPS 160. The process is initiated 400 by providing a trust enforcement policy 405 accessible by the PEPS 160. The trust enforcement policy 405 may, for example, be in the form of an XML file, binary file, text file, database file, dynamic linked library file or an object file. The trust enforcement policy 405 may include location dependent information and/or context dependent information 410.

The process continues by providing a reconnoitering application which is executable by a processor 415. The processor may be the optional processor 105 provided for the PEPS 160 or the processor 5 installed of the host processing unit 415, or both processors.

In an embodiment, the reconnoitering application 305 is automatically executed to simplify user interactions and automate determinations of the relative trusted state of the host processing unit 100. The reconnoitering application 305 accesses one or more trust dependent characteristics associated with the host processing unit 420. The trust dependent characteristics include location dependent characteristics, for example information obtained from a network protocol stack or context dependent characteristics, potential security threats, for example the presence of a malevolent tracking cookie. In another embodiment, the trust dependent characteristics may be dependent on logical and/or physical configurations associated with the host processing unit 410.

The reconnoitering application reconnoiters the host processing unit 100 in order to obtain the characteristics representative of its relative trusted state. The reconnoitering process may utilize predefined trust dependent characteristics, dynamically determined characteristics or a combination of both predefined and dynamically determined characteristics 420 based at least in part on information available from the trust enforcement policy 405.

Once the reconnoitering application 415 has obtained the trust dependent characteristics prescribed by the trust enforcement policy, a determination is then made as to the relative trusted state of the host processing unit 425. The reconnoitering application determines the relative trusted state of the host processing unit 425 from one or more trust determinate characteristics; as non exclusive examples, IP address or IP address range, MAC address, GPS coordinates, domain name, operating system footprint, an existing object, an existing trusted application, verification indicia (digital certificate, cryptographic key, digital credential, cryptogram, hash, checksum value, cyclic redundancy check value, digital signature, unique identifiers, etc.), registry entry(ies), a browser cookie(s), processes, modules and service, Windows DCOM or COM objects, DSOM objects, detected security policy (e.g., browser and/or operating system security settings, firewall setting, anti-malware applications installed, currently updated operating system version), hardware configuration (e.g., expected TPM 70 present, expected device peripherals installed, expected main memory size found, expected processor installed, etc.) or Java applet 410.

Once the relative trusted state of the host processing unit has been determined, administration of the trust dependent functional control over the PEPS 160 may be accomplished 430. The administered trust dependent functional control includes as non-exclusive examples, access to internal secure storage (i.e., vault), documents and/or internal applications; information transfer or exchange between the host processing unit and/or a network resource and the PEPS 160; malware detection, graphical display and removal; offline access and usage of temporarily and internally cached information and applications; distribution of trusted internal applications and documents from the PEPS 160 and/or from a network resource; change management of applications and documents distributed from the PEPS; internal data manipulation; PEPS application, data, policies and binary updates; required user interactions; user level(s) of access to the PEPS 160, authentication; usage of host processing unit applications, remote client invocations, PEPS 160 internal application execution, secure application downloading, and internal audit tracking 435. Processing continues until the user terminates the session with a host processing unit thus ending the process 440. The level of trust afforded by the determined relative trusted state of the host processing unit is scalable from no trust to complete trust 445.

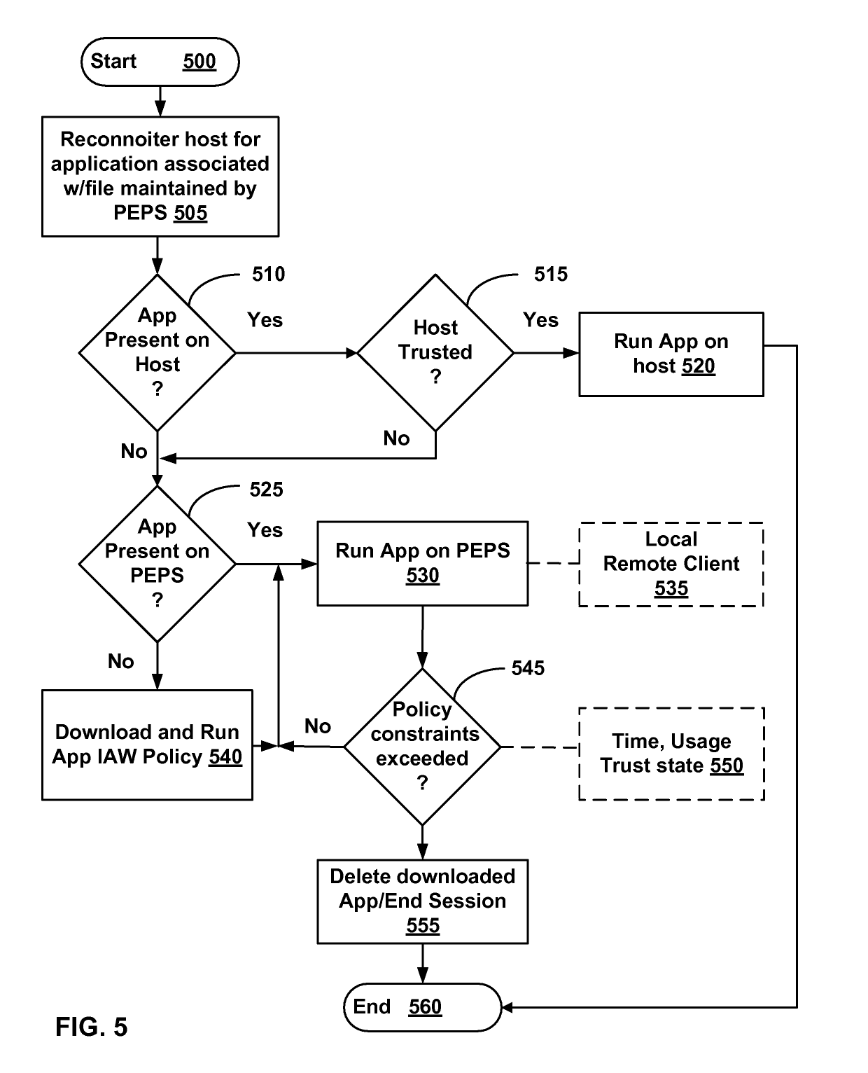

Referring to FIG. 5, another exemplary flow chart of a process is depicted. This exemplary process provides a mechanism for determining when and upon which device (PEPS 160 or local host processing unit 100) an application will be executed from in dependence on the relative trusted state afforded by the host processing unit 100. The process is initiated 500 by the reconnoitering application determining whether the host is capable of using a file maintained by the PEPS 505.

This may be accomplished by the reconnoitering application 305 determining if an existing file/application association is present in a registry associated with the operating system installed on the host processing unit 100. For example, Microsoft Windows™ maintains file extensions, associated applications and object link embedding (OLE) which utilize the format associated with the file extensions in registry entries found under HKEY_ROOT_CLASSES. In a specific example, a file such as MyInfo.TXT when selected will almost universally trigger execution of a text editing program to execute which loads the file MyInfo.TXT into the text editing program.

Other techniques may used to determine the presence of a needed application on the host processing unit 100 for example, searching for the actual application and/or locating a digital certificated associated therewith.

If the needed application is determined to be available on or through (via a remote client application) 535 the host processing unit, the PEPS 160 verifies that the host processing unit 100 has a sufficient level of trust to allow access to the file(s) securely maintained by the PEPS 515. If a sufficient level of trust has been verified, the user is allowed to run the needed application directly from the host processing unit 520. When usage of the application on the host processing unit is no longer needed, access to the file maintained by the PEPS 160 ends in accordance with (IAW) a secure application usage policy 560.

However, in many cases, the PEPS 160 may contain a file having a file extension unknown to the operating system installed on the host processing unit 510 or alternatively, if the host processing unit 100 does not have the required level of trust 515, the PEPS 160 then determines if the needed application is available internally 525. If the needed application is available internally or available using a remote client (e.g., Citrix™) 535, the needed application is then run from the PEPS 530. If the needed application is not available 525, the needed application is then downloaded to the PEPS 160 in accordance with (IAW) 540 the secure application distribution policy 345.

After execution of the needed application from the PEPS 160, a check is made to determine if one or more constraints have been met or limits exceeded 545. For example, the secure application distribution policy 345 may limit the usage of the needed application to a single usage or upon completion of a single remote client session, a defined period of time; after which, the secure application distribution policy 345 may require that the session be terminated 555.

Alternately, if the needed application is actually downloaded locally, exceeding the usage limit may require that the downloaded application be deleted from the PEPS 550. Other policy considerations may require session termination and/or needed application deletion if degradation in the level of trust is detected between the host processing unit and the PEPS 550. The process completes after the downloaded application is deleted and/or a remote client session has been terminated 560.

Various embodiments have been described in detail with reference to exemplary configurations and processes. It should be appreciated that the specific embodiments described are merely illustrative of the principles underlying the inventive concepts. It is therefore contemplated that various modifications of the disclosed embodiments will, without departing from the spirit and scope of the various embodiments, be apparent to persons of ordinary skill in the art. As such, the foregoing described inventive embodiments are provided as exemplary illustrations and descriptions. They are not intended to limit the various embodiments to any precise form described. In particular, it is contemplated that functional implementation of the inventive embodiments described herein may be implemented equivalently in hardware, software, firmware, and/or other available functional components or building blocks.

No specific limitation is intended to a particular arrangement or process sequence. Other variations and embodiments are possible in light of above teachings, and it is not intended that this Detailed Description limit the scope of inventive embodiments, but rather by the Claims following herein.

What is claimed:

1. A system for administering trust dependent functional control over a portable endpoint security device comprising:
a trust enforcement policy including one or more predefined trust dependent characteristics for which the trust dependent functional control is to be administered;
a reconnoitering application including instructions executable by a processor to;
reconnoiter one or more trust dependent characteristics associated with a host processing unit;
determine a relative trusted state of the host processing unit in dependence on the trust enforcement policy and the trust dependent characteristics reconnoitered from the host processing unit; and,
administer the trust dependent functional control over the portable endpoint security device in dependence on the determined relative trusted state of the host processing unit.

2. The system according to claim 1 wherein the administered trust dependent functional control over the portable endpoint security device is one of; controlling access to a secure memory area internal to the portable endpoint security device and controlling the transfer of information between a networked resource and the portable endpoint security device.

3. The system according to claim 1 wherein the administered trust dependent functional control over the portable endpoint security device is one of; limiting access to an internal anti-malware application, displaying graphical indicia of malware detected by the reconnoitering application on the host processing unit, removing the detected malware from the host processing unit and any combination thereof.

4. The system according to claim 1 wherein the administered trust dependent functional control over the portable endpoint security device is one of, controlling offline usage of temporarily cached information and controlling audit functions internal to the portable endpoint security device.

5. The system according to claim 1 wherein the administered trust dependent functional control over the portable endpoint security device is one of, controlling distribution of an internally maintained application, controlling usage of the internally maintained application, providing change management of the internally maintained application and any combination thereof.

6. The system according to claim 1 wherein the administered trust dependent functional control over the portable endpoint security device is one of, controlling distribution of a document, controlling access to the document and providing change management of the document.

7. The system according to claim 1 wherein the administered trust dependent functional control over the portable endpoint security device is one of, determining if an existing host application has an executable association with an internally maintained file, allowing the host application to access the internally maintained file, executing an internally maintained application, downloading an internally maintained application, and any combination thereof.

8. The system according to claim 1 wherein at least one of the one or more trust dependent characteristics reconnoitered from the host processing unit is location dependent, context dependent and any combination thereof.

9. The system according to claim 8 wherein the location dependence is inferred from one of; an IP address, an IP address range, a MAC address, a domain name, a set of GPS coordinates and any combination thereof.

10. The system according to claim 8 wherein the context dependence is inferred from one of; a memory execution stack, a registry entry, a DSOM object, Windows COM object, a Windows DCOM object, a service, a process and any combination thereof.

11. The system according to claim 8 wherein the context dependence is inferred from one of, a footprint of an operating system, a hardware configuration, an object, a binary file, a security policy, a verification indicia and any combination thereof.

12. The system according to claim 11 wherein the verification indicia is one of; a cryptogram, a digital credential, a digital signature, a checksum value, a cyclic redundancy check value, a hash value and any combination thereof.

13. The system according to claim 1 wherein the determined relative trusted state of the host processing unit is determinative of a level of access a user is afforded to information contained in or available using the portable endpoint security device.

14. The system according to claim 1 wherein the determined relative trusted state is determinative of a level of required user interaction with the portable endpoint security device.

15. The system according to claim 1 wherein the administered trust dependent functional control over the portable endpoint security device is established for one of, internal data manipulation, an application execution, an application manipulation and any combination thereof.

16. The system according to claim 15 wherein the application execution includes execution of internal maintained applications when the relative trusted state of the host processing unit is low and execution of external applications when the relative trusted state of the host processing unit is high.

17. The system according to claim 1 wherein the administered level of functional control over the portable endpoint security device is scalable in at least partial dependence on the determined relative trusted state of the host processing unit.

18. A method for administering trust dependent functional control over a portable endpoint security device comprising a trust enforcement policy including one or more predefined trust dependent characteristics for which the trust dependent functional control is to be administered coupled to a reconnoitering application including instructions executable by a processor for;
reconnoitering one or more trust dependent characteristics associated with a host processing unit;
determining a relative trusted state of the host processing unit in dependence on the trust enforcement policy and the trust dependent characteristics reconnoitered from the host processing unit; and,
administering the trust dependent functional control over the portable endpoint security device in dependence on the determined relative trusted state of the host processing unit.

19. The method according to claim 18 further including instructions executable by the processor for performing one of, controlling access to a secure memory area internal to the portable endpoint security device and controlling the transfer of information between a networked resource and the portable endpoint security device.

20. The method according to claim 18 further including instructions executable by the processor for performing one of, limiting access to an internal anti-malware application, displaying graphical indicia of malware detected by the reconnoitering application on the host processing unit, removing the detected malware from the host processing unit and any combination thereof.

21. The method according to claim 18 further including instructions executable by the processor for performing one of; controlling offline usage of temporarily cached information and controlling audit functions internal to the portable endpoint security device.

22. The method according to claim 18 further including instructions executable by the processor for performing one of; controlling distribution of an internally maintained application, controlling usage of the internally maintained application, providing change management of the internally maintained application and any combination thereof.

23. The method according to claim 18 further including instructions executable by the processor for performing one of; controlling distribution of a document, controlling access to the document and providing change management of the document.

24. The method according to claim 18 further including instructions executable by the processor for performing one of; determining if an existing host application has an executable association with an internally maintained file, allowing the host application to access the internally maintained file, executing an internally maintained application, downloading an internally maintained application and any combination thereof.

25. The method according to claim 18 wherein at least one of the one or more trust dependent characteristics reconnoitered from the host processing unit is location dependent, context dependent and any combination thereof.

26. The method according to claim 25 wherein the location dependence is inferred from one of; an IP address, an IP address range, a MAC address, a domain name, a set of GPS coordinates and any combination thereof.

27. The method according to claim 25 wherein the context dependence is inferred from one of; a memory execution stack, a registry entry, a Windows COM object, a Windows DCOM object, a DSOM object, a service, a process and any combination thereof.

28. The method according to claim 25 wherein the context dependence is inferred from one of; a footprint of an operating system, a hardware configuration, an object, a binary file, a security policy, verification indicia and any combination thereof.

29. The method according to claim 28 wherein the verification indicia is one of, a cryptogram, a digital credential, a digital signature, a checksum value, a cyclic redundancy check value, a hash value and any combination thereof

30. The method according to claim 18 wherein the determined relative trusted state of the host processing unit is determinative of a level of access a user is afforded to information contained in or available using the portable endpoint security device.

31. The method according to claim 18 wherein the determined relative trusted state is determinative of a level of required user interaction with the portable endpoint security device.

32. The method according to claim 18 wherein the administered trust dependent functional control over the portable endpoint security device is established for one of, internal data manipulation, application execution, application manipulation and any combination thereof.

33. The method according to claim 32 wherein the application execution includes execution of internal maintained applications when the relative trusted state of the host processing unit is low and execution of external applications when the relative trusted state of the host processing unit is high.

34. The method according to claim 18 wherein the administered level of functional control over the portable endpoint security device is scalable in at least partial dependence on the determined relative trusted state of the host processing unit.

35. A computer program product for administering trust dependent functional control over a portable endpoint security device embodied in a tangible form comprising instructions executable by a processor for;
reconnoitering one or more trust dependent characteristics associated with a host processing unit;
determining a relative trusted state of the host processing unit in dependence on a trust enforcement policy and the one or more trust dependent characteristics reconnoitered from the host processing unit; and,
administering trust dependent functional control over the portable endpoint security device in dependence on the determined relative trusted state of the host processing unit.

36. The computer program product according to claim 35 further including instructions executable by the processor for performing one of; controlling access to a secure memory area internal to the portable endpoint security device and controlling the transfer of information between a networked resource and the portable endpoint security device.

37. The computer program product according to claim 35 further including instructions executable by the processor for performing one of; limiting access to an internal anti-malware application, displaying graphical indicia of malware detected by the reconnoitering application on the host processing unit, removing the detected malware from the host processing unit and any combination thereof.

38. The computer program product according to claim 35 further including instructions executable by the processor for performing one of, controlling offline usage of temporarily cached information and controlling audit functions internal to the portable endpoint security device.

39. The computer program product according to claim 35 including instructions executable by the processor for performing one of, controlling distribution of an internally maintained application, controlling usage of the internally maintained application, providing change management of the internally maintained application and any combination thereof.

40. The computer program product according to claim 35 further including instructions executable by the processor for performing one of; controlling distribution of a document, controlling access to the document and providing change management of the document.

41. The computer program product according to claim 35 further including instructions executable by the processor for performing one of, determining if an existing host application has an executable association with an internally maintained file, allowing the host application to access the internally maintained file, executing an internally maintained application, downloading an internally maintained application and any combination thereof.

42. The computer program product according to claim 35 wherein at least one of the one or more trust dependent characteristics reconnoitered from the host processing unit is location dependent, context dependent and any combination thereof.

43. The computer program product according to claim 42 wherein the location dependence is inferred from one of; an IP address, an IP address range, a MAC address, a domain name, a set of GPS coordinates and any combination thereof.

44. The computer program product according to claim 42 wherein the context dependence is inferred from one of, a memory execution stack, a registry entry, a Windows COM object, a Windows DCOM object, a DSOM object, a service, a process and any combination thereof.

45. The computer program product according to claim 42 wherein the context dependence is inferred from one of, a footprint of an operating system, a hardware configuration, an object, a binary file, a security policy, verification indicia and any combination thereof.

46. The computer program product according to claim 45 wherein the verification indicia is one of; a cryptogram, a digital credential, a digital signature, a checksum value, a cyclic redundancy check value, a hash value and any combination thereof.

47. The computer program product according to claim 35 wherein the determined relative trusted state of the host processing unit is determinative of a level of access a user is afforded to information contained in or available using the portable endpoint security device.

48. The computer program product according to claim 35 wherein the determined relative trusted state is determinative of a level of required user interaction with the portable endpoint security device.

49. The computer program product according to claim 35 wherein the administered trust dependent functional control over the portable endpoint security device is established for one of, internal data manipulation, internal application manipulation, application execution and any combination thereof.

50. The computer program product according to claim 49 wherein the application execution includes execution of internal maintained applications when the relative trusted state of the host processing unit is low and execution of external applications when the relative trusted state of the host processing unit is high.

51. The computer program product according to claim 35 wherein the tangible form is one of; magnetic media, optical media, logical media and any combination thereof.
